(19) United States
(12) Patent Application Publication
(10) Pub. No.: US 2004/0225709 A1
(43) Pub. Date: Nov. 11, 2004

(54) Automatically configuring security system

(76) Inventors: Joseph Kubler, Boulder, CO (US); John Walter, Cedar Rapids, IA (US); Gary Spless, Usbon, IA (US)

Correspondence Address: ORUM & ROTH, 53 W. JACKSON BLVD, CHICAGO, IL, 60604, US

(21) Appl. No.: 10/772,801

(22) Filed: Feb. 5, 2004

Related U.S. Application Data
(60) Provisional application No. 60/444,894, filed on May 6, 2003.

(51) Int. Cl. G06F 15/16

(52) U.S. Cl. 709/200

(57) ABSTRACT

A method for automatically creating random passwords for a client device and adding those passwords to a database of authorized users of a network. The device automatically generates credential data. The credential data is communicated to an authentication server. The authentication server automatically adds the credential data to a database of authorized users.

The present application claims the benefit of U.S. Provisional Application 60/444894, filed Feb. 5, 2003. That application is hereby incorporated in its entirety.

### BACKGROUND OF THE INVENTION

1. Field of the Invention

The present invention generally relates to secure systems communicating in local area network and, more particularly, to wireless hand-held devices that automatically create the user's ID and related secret information in the server's database without requiring manual entry such information by the users or administrator of the system.

2. Description of Related Art

A general concept of automatically configuring security systems has been discussed in a number of U.S. patents and publications. However, when a security system is incorporated in hand-held devices with wireless capabilities for communication in local area networks, significant problems related to the creation of reliable and good passwords and user's ID's for all hand-held devices arise. At present time a system administrator has to enter the user's IDs and passwords for all the hand-held devices. Furthermore, the system administrator has to make sure that the passwords are sufficiently different and random to prevent the potential compromise of the system. There is a need for a system that automatically creates secure login data.

### SUMMARY OF INVENTION

The present invention is a system to automatically create completely random passwords and add them into the server's database in a secure manner that prevents eavesdropping and yet uses wireless LAN to accomplish it.

Briefly, and in general terms, the present invention provides a system including an authentication server and one or more client devices, which automatically create the user IDs and/or related data such as passwords in the client device and update or creates in the server database without requiring manual entry by the users and/or administrator of the system.

### BRIEF DESCRIPTION OF THE DRAWINGS

FIG. 1 is a simplified schematic drawing of the system architecture.

FIG. 2 is a simplified schematic drawing of the system implementation.

FIGS. 3A and 3B are a simplified schematic drawing of the autolearn mode of the system.

FIG. 4 is a simplified schematic drawing of Logging Mode of the system.

### DETAILED DESCRIPTION OF THE INVENTION

Often when a new device is added to a network or new software is added, it is necessary to register authorized users, so they have access to the network. The present invention is an automated process of generating passwords.

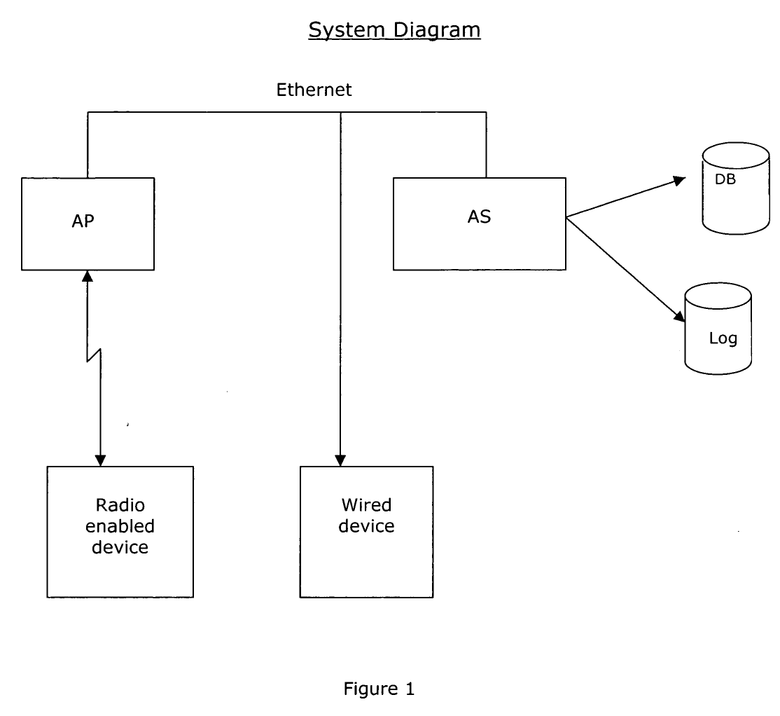

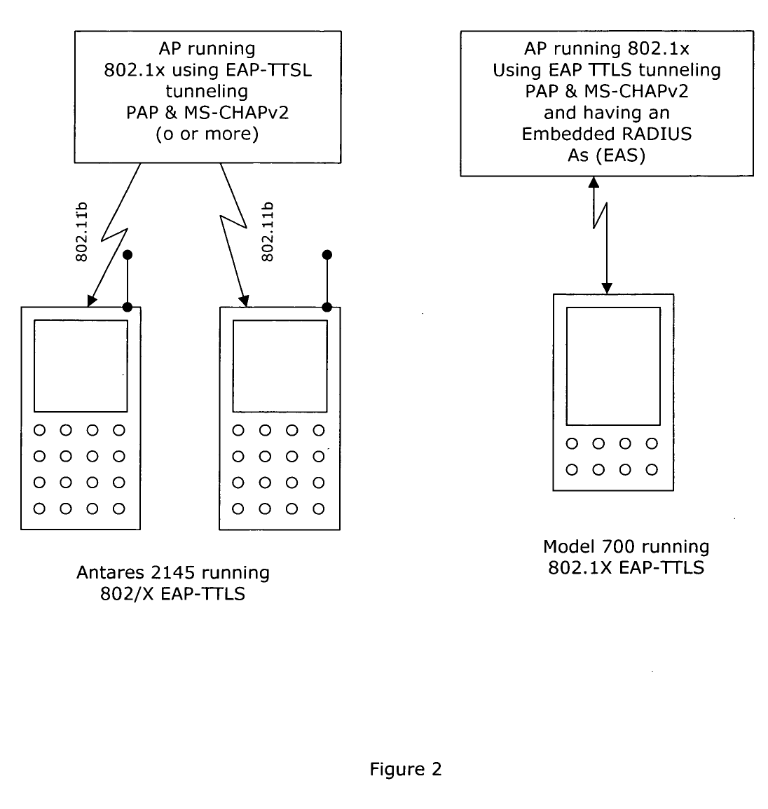

The preferred embodiment of the present invention is a wireless LAN such as 802.11 networks with the Authentication Server (AS) implemented in at least one Access Point (AP), see FIG. 1, FIG. 2. The APs, and client devices, which may include portable devices (for example, hand-held devices, laptops, printers, scanners, etc.), are connected via the wireless LAN. Additionally, wired devices may also be connected. Preferably, some authentication protocol such as 802.1 X is used. The higher layer protocol used with 802.1 X is one that uses public key infrastructure (PKI). The client will set up a secure connection such as an encrypted connection or a physically secure connection. For instance, encryption may be accomplished by the use of the Secure Sockets Layer (SSL) protocol or Transport Layer Security (TLS) protocol. The client may first authenticate the AS and verify its certificate. This is necessary only if there is no other way to guarantee that the only AS is the one desired. In any case, the client and AS will further authenticate by the use of the secure connection. This whole process could be performed with a higher layer protocol defined, for instance, by EAP-TTLS.

It is preferable that the authentication comprises of a user's ID and password from the client device. However, just a password could be used or even other credential data could be used. In normal operation, passwords are not sent, but instead, as is done in cryptographic authentication protocols, the password is used to compute a random value from other information provided in the authentication process: such procedure is called challenge and respond protocol. The example of such second protocol is Microsoft's version of Challenge Handshake Authentication Protocol, version 2 (MS-CHAPV2). To authenticate the client, as someone authorized or permitted access to the network, the AS must have the device and/or user credentials such as the user's ID and password.

The present invention automatically creates the credentials and the required database for the authentication. In the beginning, the device is put into a mode that will make the device send its user's ID and unmodified password. Preferably, the password is generated automatically by the device. Alternatively, the user may select a password. It is preferable that cryptographic obfuscation not be performed on the password. A typical protocol for this step is Password Authentication Protocol (PAP). The secure connection, such as an encrypted connection or performing the registration in a physically secure location, should be used during this step; therefore, no eavesdropper can determine the user's ID and password pair.

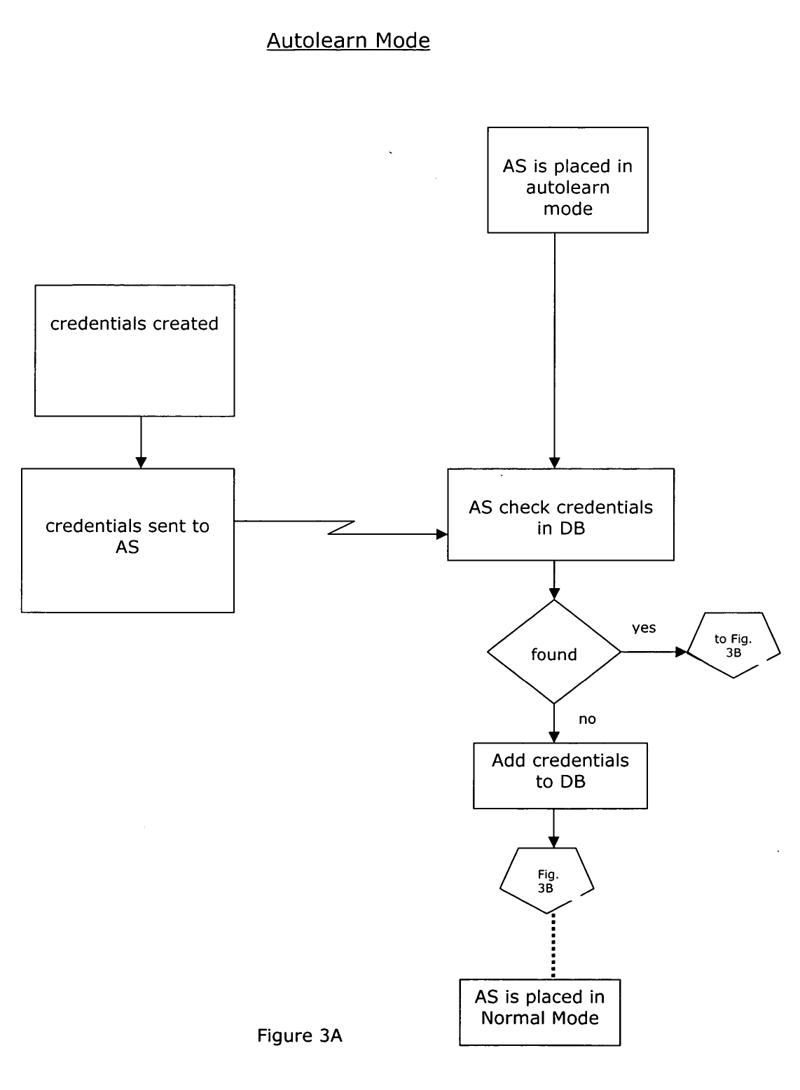

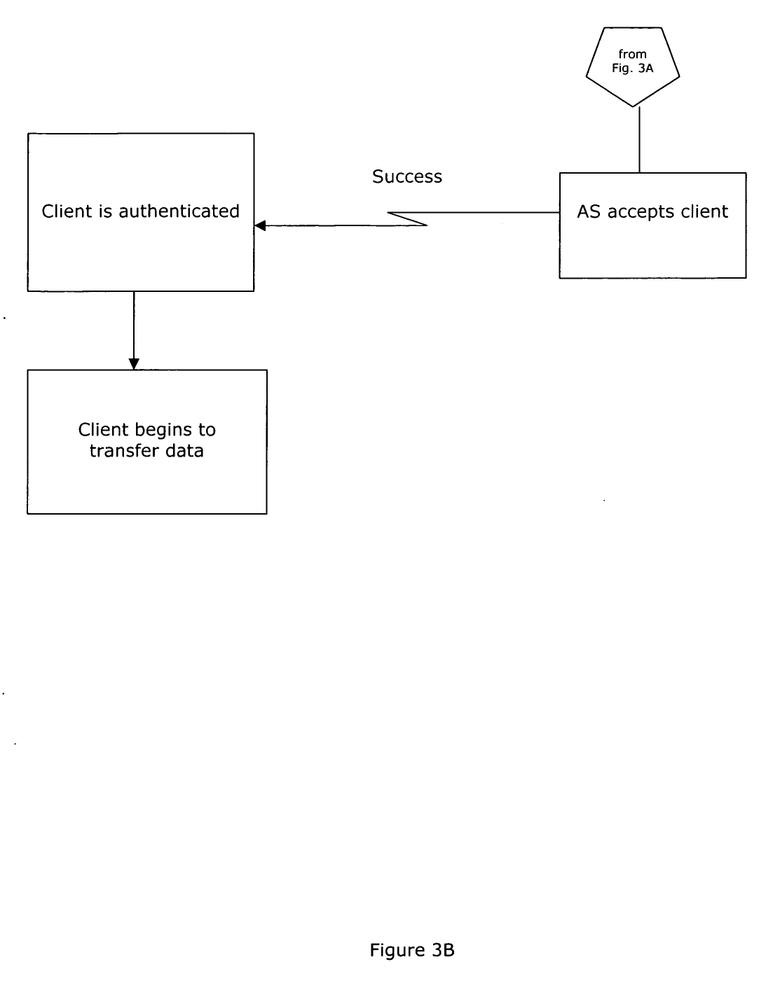

In a first embodiment, the AS is placed in Autolearn Mode, see FIG. 3. The AS will add the entry to the database (marked as a new entry, perhaps), authenticate the client device, and allow it access to the network. The system administrator will exit this mode and any further attempt to authenticate the credential will use the normal challenge and respond protocols. The system administrator can delete unauthorized users or devices at any time. Preferably, after the idle time, or at the system administrator discretion, the Autolearn mode will be disabled and the system will return to the normal mode.

In an alternative embodiment, the AS will be in Looging Mode, the system administrator will verify that the user and/or device is permitted or authorized to access the network. The credentials will then be added to the database.

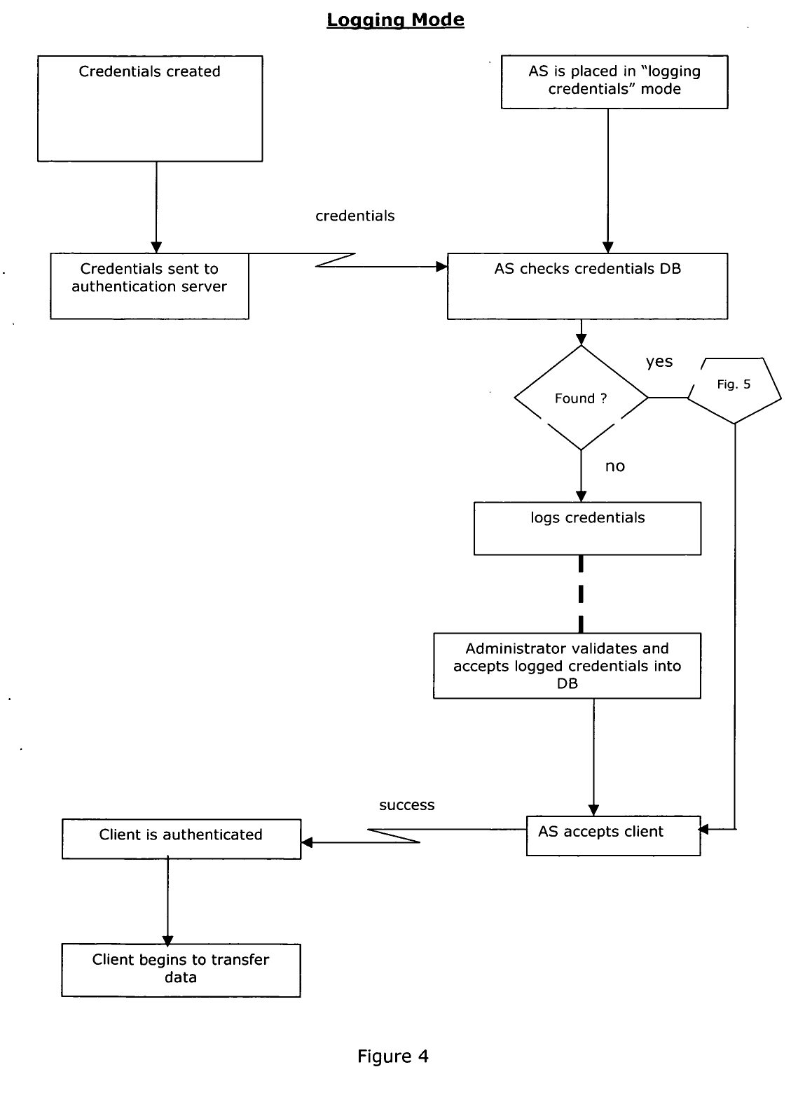

The AS is logging entries, meanwhile refusing access to a new client, see FIG. 4. The user may exit this mode and attempt to log in to the network normal cryptographic methods such as challenge and response protocol. The system administrator can verify that the logged client information is acceptable and accept it into the database.

1. A method for automatically generating a credential database, comprising the following steps:
connecting at least one client device to a network having an authentication server;
generating credential data by the at least one client device;
sending the credential data to the authentication server; and
adding the credential data to a database of credential data.

2. The method for automatically generating a credential database of claim 1 further comprising the steps of:
placing the authentication server into autolearn mode before the credential data is sent; and
returning the authentication server to normal mode after the credential data is added to the database.

3. The method of claim 2 wherein the credential data is sent in a secure environment.

4. The method of claim 3 wherein the credential data is encrypted before it is sent to the authentication server.

5. The method of claim 3 wherein the authentication server and the at least one client device are in a physically secure location when the data is sent.

6. The method of claim 3 comprising the additional step of verifying the at least one device is authorized to access the network.

7. The method of claim 6 comprising the additional step of deleting credential data for any unauthorized devices.

8. The method of claim 1 comprising the additional steps of
verifying the at least one device is authorized to access the network before the credential data is added to the database.

9. The method of claim 8 wherein the credential data is sent in a secure environment.

10. The method of claim 9 wherein the credential data is encrypted before it is sent to the authentication server.

11. The method of claim 9 wherein the authentication server and the at least one client device are in a physically secure location when the data is sent.

12. The method of claim 8 comprising the additional steps of
placing the authentication server in logging mode before credential data is sent; and
returning the authentication server to normal mode after the credential data has been added to the database.

13. The method of claim 2 wherein the credential data is sent by a wireless communication link.

14. The method of claim 2 wherein the credential data is sent by a hard wired communication link.

15. The method of claim 8 wherein the credential data is sent by a wireless communication link.

16. The method of claim 8 wherein the credential data is sent by a hard wired communication link.

17. A method for automatically generating a credential database for a plurality of client devices, comprising the steps of:
connecting a client device to a network having an authentication server;
generating credential data by the client device;
sending the credential data to the authentication server;
adding the credential data to a database of credential data; and
repeating the steps until the credential data for the plurality of client devices has been added to the database.

18. The method for automatically generating a credential database of claim 17 further comprising the steps of:
placing the authentication server into autolearn mode before the credential data is sent; and
returning the authentication server in normal mode after the credential data is added to the database.

19. The method of claim 18, comprising the additional steps of
verifying the client devices are authorized to access the network; and
deleting the credential data for any unauthorized client devices.

20. The method of claim 17 comprising the additional steps of
verifying the client devices are authorized to access the network before the credential data is added to the database.
